(19) United States
(12) Patent Application Publication
(10) Pub. No.: US 2026/0352150 A1
(43) Pub. Date: Nov. 5, 2026

(54) System and Method for Constructing a Row of Solar Panels

(71) Applicant: JSI Equipment Solutions LLC, Boulder, CO (US)

(72) Inventor: Max Reed, Longmont, CO (US)

(73) Assignee: JSI Equipment Solutions LLC, Boulder, CO (US)

(21) Appl. No.: 19/388,698

(22) Filed: Nov. 13, 2025

Related U.S. Application Data
(60) Provisional application No. 63/798,716, filed on May 2, 2025.

(51) Int. Cl. H02S 40/20; H02S 20/32

(52) U.S. Cl. CPC H02S 40/20; H02S 20/32

(57) ABSTRACT

During construction of a row of solar panels, components are aligned using an alignment fixture and targets. The fixture and the targets are each mounted onto brackets that are adjustably coupled to posts installed in the ground. The fixture is on a post in the mid-section of a row of posts, and the targets are on posts at opposite ends of the row. A laser in the alignment fixture emits coaxial dual laser beams towards the two targets. Manual sights on the fixture are used to align the lasers with the targets. The lasers are aligned with centers of the targets by manipulating lateral and tilt adjustments in the fixture, and repositioning the brackets. After aligning the laser beams with the targets, the alignment fixture is secured, and the targets are moved to closer posts and the procedure is repeated.

### CROSS-REFERENCE TO RELATED APPLICATION

This application claims priority to and the benefit of co-pending U.S. Provisional Application Ser. No. 63/798,716, filed May 2, 2025, the full disclosure of which is incorporated by reference herein in its entirety and for all purposes.

### BACKGROUND OF THE INVENTION

### 1. Field of Invention

The present disclosure relates to construction of a solar assembly, and more particularly, relates to aligning structure in a row of solar panels.

### 2. Description of Prior Art

Photovoltaic panels, or modules, generate electricity from captured sunlight. Modules are generally either mounted on a fixed structure or on a moveable structure that tracks the sun. For single axis solar trackers, the modules are installed onto rows of a supporting structure that form a solar field, where each row generally runs north/south. A single row of modules with supporting structure and orientation hardware is sometimes referred to as a tracker. To effectively capture sunlight throughout the day, the tracker automatically rotates the modules to follow the sun's arc throughout the day. The modules are mounted to a torque tube that is rotated, which in turn rotates the modules to change their tilt angle. The torque tube is a structural tube that spans each row and is supported on posts anchored into the ground. The torque tube rotates about an axis of rotation, which is either coaxial or eccentric to the torque tube depending on the design of the tracker. The torque tube is often made up of multiple sections that are coupled together during construction, with the total length of the torque tube typically ranging from 150 feet to 400 feet.

Usually, a bearing assembly is attached on each of the posts to provide support and smooth rotation for the torque tube. Due to installation tolerances, the actual installed location of the top of the post is often offset from nominal. If no adjustments are made to the offset, axes of the bearing assembly and a portion of the torque tube on that bearing assembly will not be coaxial with the common axis of rotation. A drive system is connected to the torque tube and provides rotational movement about an axis of rotation, and which provides the torque to rotate the torque tube and modules. Adjustment is generally provided in the drive system to align the axes of rotation of the drive system and torque tube.

If the mounts on which the torque tube is supported are not properly aligned so that the torque tube axis is not substantially straight, additional torque is required to drive the system potentially causing mechanical binding and premature wear on system components. Although construction practices vary with each tracker manufacturer, two common ways to align these mounts is either the use of string stretched along the full row, or a laser set on a tripod from one end of the row shooting the full length of the row to provide a datum. The use of string is often unsatisfactory because wind and/or gravity can create localized undulations in string. Projecting a laser from one end of a row can be challenging, because the laser spot size grows with distance, so an accurate laser position is not easily achieved over long distances. The intensity of the laser spot decreases with longer distances, so over long distances, it is more difficult to see the laser spot in the sunny outdoor environment. Combining these two effects over long distances the spot size becomes difficult to see and inaccurate for alignment purposes. An additional challenge with the prior art is the difficulty to align the position and orientation of the drive system to be coaxial with the desired axis of rotation of the torque tube.

### SUMMARY OF THE INVENTION

Disclosed herein is an example method of constructing a solar field, which includes securing a target assembly to a first mount that is coupled with a first post set in the ground, the target assembly made up of a reflective medium with a center that is disposed at a designated location with respect to the first mount. The method also includes securing an alignment fixture to a second mount that is coupled with a second post set in the ground a distance from the first post, the alignment fixture made up of a housing with sidewalls, a laser coupled with the housing, and apertures formed through the sidewalls, energizing the laser to generate a laser beam, intersecting the laser beam with the reflective medium by adjusting placement of the housing to form a line of sight path between the housing and the reflective medium and that intersects the apertures, aligning the laser beam with a center of the reflective medium, and installing a torque tube between the first mount and the second mount so that the axis of rotation of the torque tube is coaxial with a path of the laser beam when aligned with the center of the reflective material. In an example, the first mount is coupled to the first post by a first bracket that is laterally and vertically adjustable with respect to the first post, and the step of aligning includes adjusting a position of the first bracket with respect to the first post. In an alternative, the second mount is coupled to the second post by a second bracket that is laterally and vertically adjustable with respect to the second post, and where aligning includes adjusting a position of the second bracket with respect to the second post, and optionally supporting the second mount on the second post with an elevator assembly made up of a base that is releasably coupled with the second post, a pedestal supporting a lower end of the second mount, and a lifting screw threadingly engaged with the base and having an end abutting a side of the pedestal opposite the second mount, and a quick release tab to selectively disengage the lift screw from the base. The step of alignment optionally includes laterally moving the alignment fixture with respect to the second mount. In an alternative, the target assembly is a first target assembly and the reflective medium is a first reflective medium, the method of this example further includes securing a second target assembly to a third mount that is coupled with a third post set in the ground on a side of the second post opposite the first post, the second target assembly having a second reflective medium with a center that is disposed at a designated location with respect to the third mount. In an alternative, the laser beam is a first laser beam, the method further includes projecting a second laser beam from a side of the laser opposite the first laser beam and that is coaxial with the first laser beam. The method further optionally includes aligning the second laser beam with the center of the second reflective medium by adjusting a position of the third mount. The example method further optionally includes aligning the center of the second reflective medium with the second laser beam by adjusting a position of the second mount. In an embodiment, the target assembly is a first target assembly and the reflective medium is a first reflective medium, the method further including securing a second target assembly to a third mount that is coupled with a third post set in the ground on a side of the second post opposite the first post, wherein the second target assembly is in a designated position and a designated orientation with respect to the third mount, the second target assembly comprising a second reflective medium, wherein the laser beam comprises a first laser beam, the method further comprising projecting a second laser beam from a side of the laser opposite the first laser beam and that is coaxial with the first laser beam, the method further comprising aligning the first laser beam with the center of the first target and aligning the second laser beam with the center of the second target by adjusting a lateral position of the alignment fixture. An example of the step of alignment further includes adjusting a tilt of the alignment fixture. The method further optionally includes installing a drive gear to the second mount and coupling the torque tube to the drive gear.

Also disclosed is an example of a system for aligning mounts on spaced apart posts in a solar field, the example system includes a target assembly having a reflective medium, the target assembly strategically dimensioned, so that when the target assembly is coupled to a first one of the posts, the reflective medium is disposed in a designated orientation and at a designated location, and an alignment fixture selectively coupled with a second one of the posts, the alignment fixture having a housing with sidewalls and upper and lower walls extending between the sidewalls, a laser coupled with the housing that selectively projects a laser beam towards the reflective medium, and apertures formed in the sidewalls at strategic locations, so that when the target is viewable through the apertures, the reflective medium is in a path of the laser beam. The target assembly is optionally coupled to the first one of the posts by a first bracket, where the alignment fixture is coupled to the second one of the posts by a second bracket, where when the reflective medium is in the path of the laser beam, positions of the first and second brackets are strategically adjustable by amounts so that the laser beam intersects a center of the reflective medium. In another example, the system further includes a target mount releasably coupled with a first one of the mounts and strategically dimensioned so that when coupled with the first one of the mounts the reflective medium is in the designated position and orientation. The system further optionally includes an elevator assembly having a base that is releasably coupled with one of the posts, a pedestal supporting a lower end of a one of the mounts, and a lifting screw threadingly engaged with the base and having an end abutting a side of the pedestal opposite the one of the mounts, and a quick release tab to selectively disengage the lift screw from the base. In an alternative, the laser beam is a first laser beam, where the laser selectively generates a second laser beam that is coaxial with the first laser beam and in an opposite direction.

### BRIEF DESCRIPTION OF DRAWINGS

Some of the features and benefits of the present invention having been stated, others will become apparent as the description proceeds when taken in conjunction with the accompanying drawings, in which:

FIG. 1 is a perspective view of an example of a solar tracker row.

FIG. 2 is a perspective view of an example of an alignment step when constructing the solar tracker row of FIG. 1.

FIGS. 3A and 3B are perspective views of an example step of aligning mounts on posts when constructing the solar tracker row of FIG. 1.

FIG. 4 is a perspective view of an example of an alignment fixture for use in the alignment step of FIG. 2.

FIG. 5 is a perspective view of an example of using the alignment fixture of FIG. 4.

FIG. 6 is a perspective view of an example of another alignment step when constructing the solar tracker row of FIG. 1.

FIG. 7A is a perspective view of an example of a drive gear on a drive mount aligned on a post in accordance with the present disclosure.

FIG. 7B is a perspective view of an example of a bearing assembly on a bearing mount aligned on a post in accordance with the present disclosure.

While subject matter is described in connection with embodiments disclosed herein, it will be understood that the scope of the present disclosure is not limited to any particular embodiment. On the contrary, it is intended to cover all alternatives, modifications, and equivalents thereof.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of a cited magnitude. In an embodiment, the term “substantially” includes +/−5% of a cited magnitude, comparison, or description. In an embodiment, usage of the term “generally” includes +/−10% of a cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

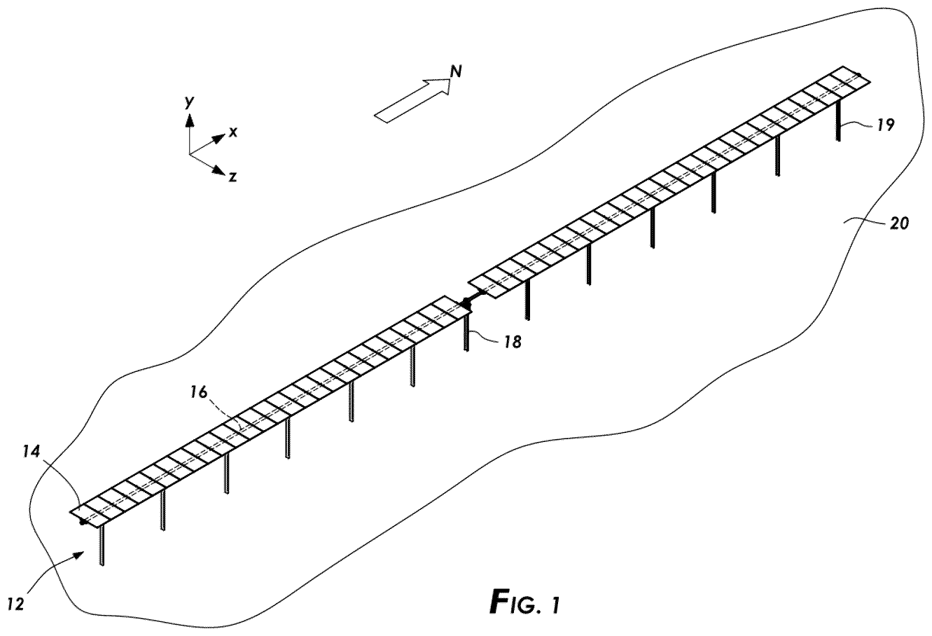

Shown in a perspective view in FIG. 1 is an example of a row 12 of solar modules 14 that are shown mounted onto a torque tube 16. In this example, row 12 is oriented along a North-South path, and included for reference in FIG. 1 is a three dimensional X-Y-Z coordinate axis. Posts 18, 19 are shown mounted vertically in the Earth's surface 20, posts 18, 19 provide support for the row 12 and its associated hardware. The solar modules 14 of FIG. 1 convert solar energy into electricity for powering electrical devices. Embodiments exist in which row 12 is included with a number of other rows to form a solar power plant (not shown) that provides multiple megawatts of electricity.

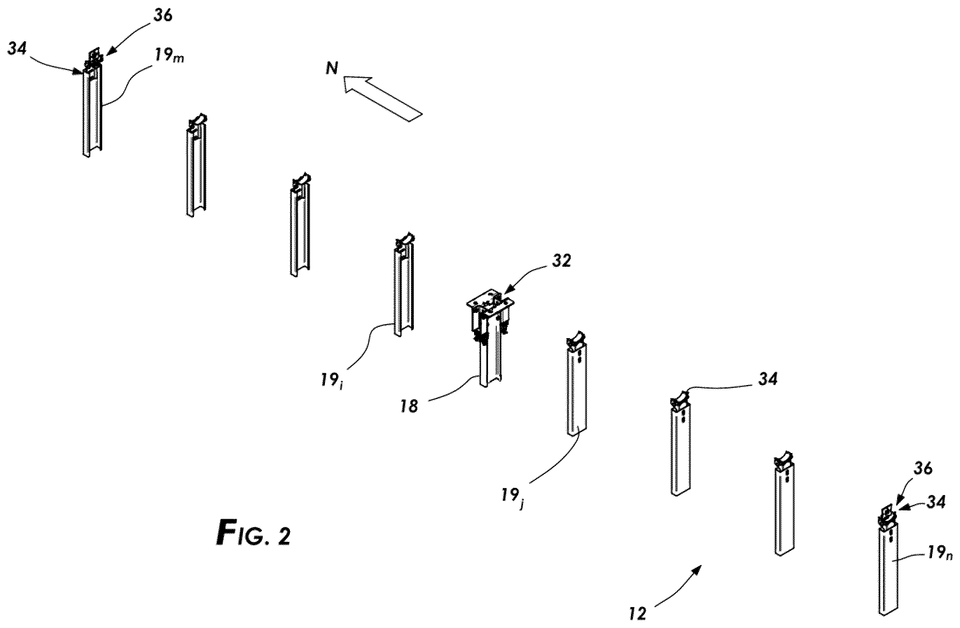

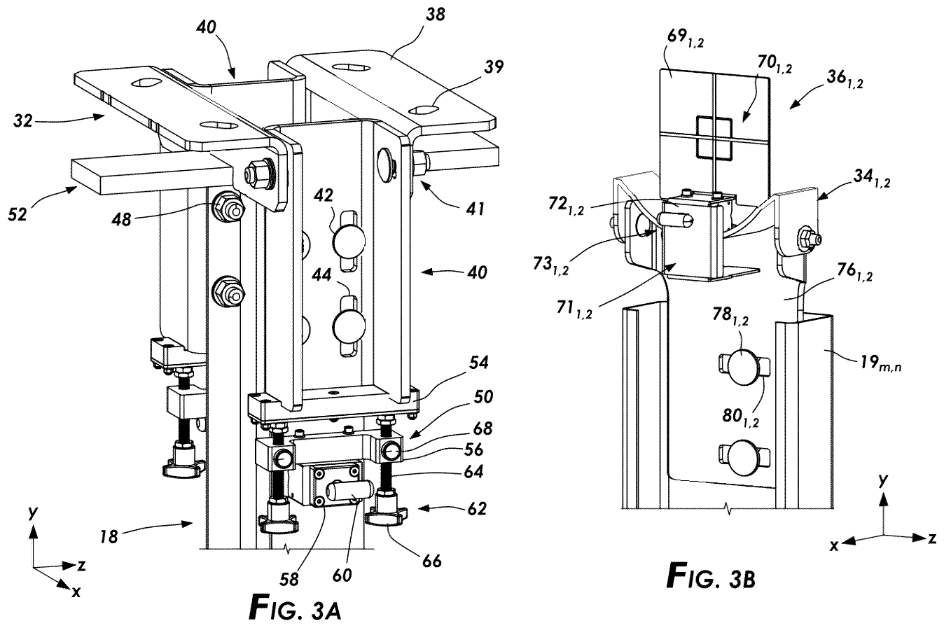

In FIG. 2 is an example step of constructing a row 12 of the solar power plant 10 of FIG. 1. In this example, a drive mount 32 is positioned on post 18, each of the remaining posts 19i-m, j-n have a bearing mount 34 set on their upper ends. The number of posts 18, 19i-m, j-n is not limited to nine as shown in FIG. 2 but includes rows 12 have any number of posts. A target assembly 36 is set on bearing mounts 34 of posts 19_{m,n} on opposite ends of the row 12. As shown in greater detail in FIG. 3A, the drive mount 32 includes an upper bracket 38 having a pair of spaced apart members, each member having planar rectangular sections, where the first section is in the X-Z plane and the second section is in the X-Y plane. A pair of spaced apart bores 39 are formed through each of the first sections. Between the members of the upper bracket 38 is a lower bracket 40, also made up of a pair of members that each have a channel iron configuration with their respective web portions in the Y-Z plane and flange portions in the X-Y plane. Threaded fasteners 41 are shown connecting an upper end of each flange portion to a lateral end of each second section. Bolts 42 are shown inserted into slots 44 formed through web portions of the lower bracket 40. Nuts 48 engage threaded portions of the bolts 42, and tightening the bolts 42 with the nuts 48 attaches the lower bracket 40 and drive mount 32, to the post 18. The slots 44 are rectangular and have an elongated height extending along the Y axis, which exceeds the diameter of bolts 42 to allow for selective vertical positioning of the drive mount 32 with respect to post 18.

During assembly and prior to tightening bolts 42, the drive mount 32 is supported in its position on the post 18 by an elevator assembly 50 that is releasably coupled to the post 18. Optionally, prior to setting the drive mount 32 on post 18 a shim or spacer 52 is set on an upper end of the post 18 and before adding the elevator assembly 50. Using shim 52 to place drive mount 32 a distance above the post 18 allows a downward adjustment to the drive mount 32 position on post 18. Included with elevator assembly 50 is a rectangularly shaped pedestal 54 shown in supporting contact with lower terminal ends of the lower bracket 40. Elevator Assembly 50 also includes a base 56 and a magnetic coupling 58. Magnetic coupling 58 is selectively activated and deactivated by rotating switch 60 shown on its forward surface, when activated a magnetic field or magnetic coupling is generated to secure the elevator assembly 50 to the post 18. The position of pedestal 54 relative to base 56 is selectively adjusted with elevator adjustments 62, which include threaded lifting screws 64 that project axially through openings in the base 56 and have upper ends that are in abutting contact with a lower surface of the pedestal 54. Rotating the adjustments 62 clockwise or counterclockwise adjusts the position of the pedestal 54 relative to base 56, and also the drive mount 32 when supported on the pedestal 54.

Still referring to FIG. 3A, each elevator assembly 50 includes a pair of elevator adjustments 62 so that selective rotation of either adjusts a tilt angle of the drive mount 32. A knob 66 is shown on the lower end of each lifting screw 64 to facilitate its rotation. Also included with each elevator assembly 50 are release tabs 68 shown on an outer surface of the base 56. The tabs 68 are set in bores formed into the base 56, urging the tabs 68 into the base 56 disengages threads within the base 56 coupled with threads on the lifting screws 64 to allow free movement of the lifting screws 64 with respect to the base 56. In an example, tabs 68 are depressed and lifting screw(s) 64 are quickly urged through 56 to move pedestal 54 into or away from engagement with lower bracket 40 and in less time than if the pedestal 54 is moved by rotating the lifting screws 64.

Referring now to FIG. 3B, shown in a perspective view is an example of the posts 19_{m, n} which are at opposite ends of the row 12 of FIG. 2. On each of the posts 19_{m,n} is a target assembly 36 shown coupled onto the bearing mount 34. The target assembly 36 includes a target 69, which is a planar member made from a material having adequate resilience to resist deformation due to wind or other forces, and with a reflectance value of sufficient magnitude so that a laser beam irradiating the target 69 is visible. Crosshair marks 70 are on the target 69, which indicate a center of the target 69. A target mount 71 is included with the target assembly 36 for engaging the target assembly 36 with the bearing mount 34. With the target mount 71 is a magnetic coupling 72 that is similar to the magnetic coupling 58 of FIG. 3A. Coupling 72 is activated and deactivated by rotating switch 73 on its forward housing. The bearing mount 34 is shown attached to a bracket 76 that is coupled to post 19ₘ, n by a bolt 78. The bolt 78 extends through a longitudinal slot 80 formed in bracket 76. Similar to slot 44 of FIG. 3A, slot 80 allows for the lateral position of the bracket 76 to be adjusted with respect to post 19_{m,n}, and also adjustment to the lateral position of the target assembly 36.

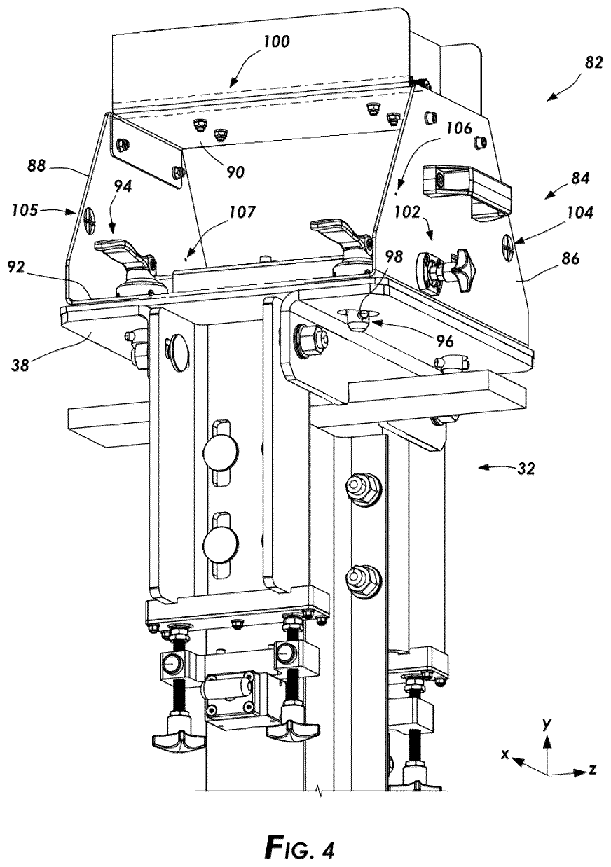

Referring now to FIG. 4, shown in a perspective view is an example of an alignment fixture 82 set on the upper bracket 38 of the drive mount 32. Fixture 82 includes a housing 84 which has planar sidewalls 86, 88 that lie within the X-Y plane of FIG. 4. An upper wall 90 spans between upper ends of the sidewalls 86, 88, and a lower wall 92 extends between lower ends of the sidewalls 86, 88. On the lower wall 92 are cam levers 94 for temporarily securing the alignment fixture 82 to the drive mount 32. As shown, the cam levers 94 each include cam studs 96 that project downwardly from the lower wall 92 and through bores 39 that are formed axially through the upper bracket 38. Locking studs project radially outward from the cam studs 96, so that rotating the handle on the cam lever 94 prevents the cam stud 96 from being pulled upward through the bores 39. Shown in a dashed outline and mounted on the upper wall 90 is a dual laser 100, which as described in more detail below simultaneously projects forward and rearward oriented laser beams that are coaxial with one another. A yaw adjustment 102 is shown having a knob projecting laterally outward from side wall 86 that when rotated rotates the fixture 82 about the Y axis. Further shown in FIG. 4 are apertures 104, 105 and eyeholes 106, 107, where aperture 104 and eyehole 106 are formed in sidewalls 86 and aperture 105 and eyehole 107 are formed in sidewalls 88. Aperture 104 is across from and corresponds to eyehole 107, and formed laterally through sidewall 86 is an aperture 105 that is across from and corresponds to eyehole 106. Optional crosshairs are provided within apertures 104, 105, and the diameters of eyeholes 106, 107 is smaller than those of apertures 104, 105.

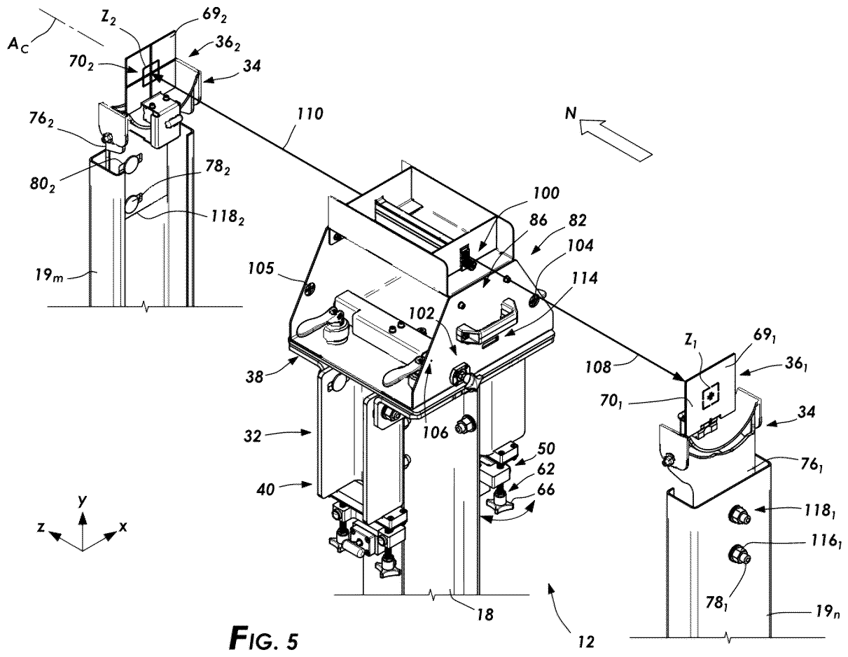

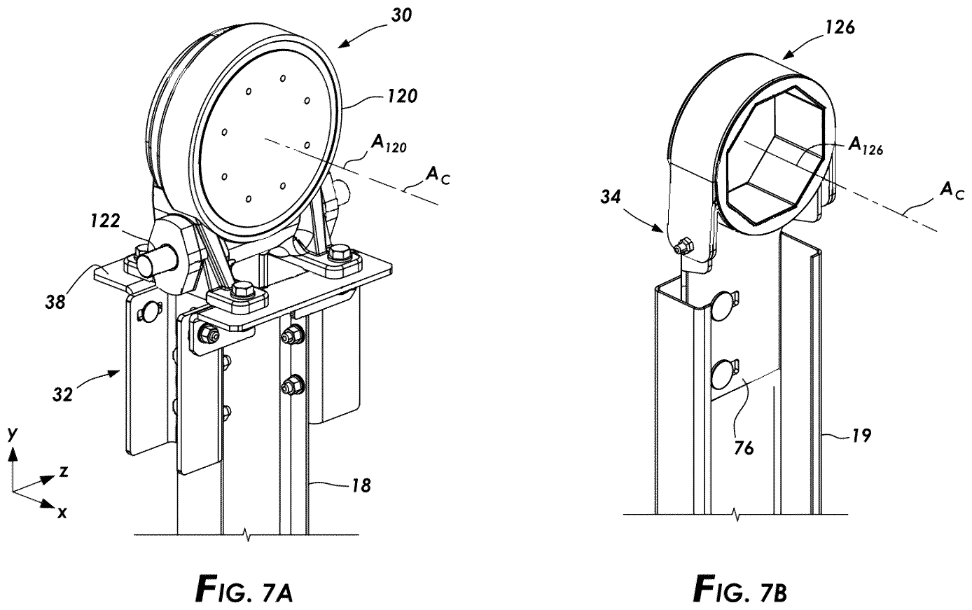

Referring now to FIG. 5, shown in perspective view is an example of using the alignment fixture 82 to align and adjust positions of bearing mount 34 on post 19_{m,n} and the drive mount on post 18. For the sake of simplicity, posts between the alignment fixture 82 and posts 19_{m, n} are not shown. At this stage of the alignment, shim 52 (FIG. 3A) has been removed from under the drive mount 32. In this example, the laser 100 is energized to generate laser beams 108, 110 that project from opposite ends of the dual laser 100 towards reflective mediums 69_{1,2} of the target assemblies 36_{1,2}. In an alternative, the alignment fixture 82 is initially positioned so that target medium 69₂ is visible when looking through eyehole 106 and aperture 105 (i.e., a line of sight from target 69₂ that intersects eyehole 106 and aperture 105) and target medium 69₁ is visible when looking through eyehole 107 and aperture 104 (i.e., a line of sight from target 69₁ that intersects eyehole 107 and aperture 104). The eyeholes 106, 107 and apertures 104, 105 are located at strategic location on the housing of the alignment fixture 82 so that the lasers beam 108, 110 will intersect and be visible on the reflective mediums 69_{1,2}. The apertures 104, 105 and eyeholes 106, 107 operate as manual sights for quickly positioning the alignment fixture 82 into a rough alignment so that reflections of the laser beams 108, 110 onto the reflective mediums 69_{1,2}. Examples of alternative manual sights include devices attached to the fixture 82, such as an annular tube similar to an optical scope or spaced apart sights on the fixture 82 (i.e., iron sights, tower sights, flip sights, etc.), and optionally the manual sights are made up of notches on an outer surface of the fixture. A significant advantage is provided by eyeholes 106, 107 and apertures 104, 105 by reducing the area of the reflective mediums 69_{1,2} and the time required to position both laser beams 108, 110 onto their respective reflective mediums 69_{1,2}. After completing the initial or “rough” alignment, laser beam 108 is centered onto target medium 69₁ and laser beam 110 is centered onto reflective medium 69₂ by positional adjustments of brackets 76_{1,2} with respect to posts 19_{m,n}, positional adjustments of alignment fixture 82 with respect to post 18, or both. Examples of positionally adjusting alignment fixture 82 with respect to post 18 include manipulating one or more of the elevator adjustments 62 of elevator assembly 50, manually moving the drive mount 32 laterally, or using the yaw adjustment 102. A level sensor 114 is shown on sidewall 86 for adjusting East-West tilt, using the level sensor 114 the East-West tilt is adjusted to 0°+/−0.5°. After centering lasers 108, 110 on the crosshair marks 70_{1,2} of their respective target assemblies 36_{1,2}, brackets 76_{1,2} are secured to posts 19_{m,n} by tightening bolts 78_{1,2} and corresponding nuts 116_{1,2}. Vertical slots 118_{1,2} are shown formed in posts 19_{m,n} which provide for optional vertical positioning of brackets 76_{1,2} with respect to posts 19_{m,n}. The drive mount 32 is also secured in its aligned position by tightening bolts 42 (FIG. 3A) with their respective nuts (not shown). When the brackets 76_{1,2} and drive mount 32 are aligned as described herein, lasers 108, 110 are coincident with the axis A_{C} of common rotation. Further, the target assemblies 36_{1,2} are strategically dimensioned to locate the centers of the crosshair marks 70_{1,2} at a designated location that is intersected by an axis of a torque tube 16 (FIG. 1) when installed onto the bearing mount 34, and the alignment fixture 82 is strategically dimensioned to locate an axis of the laser 100 coincident with the axis of the torque tube 16 when coupled with a bearing assembly 126 (FIG. 7B) installed on bearing mount 34.

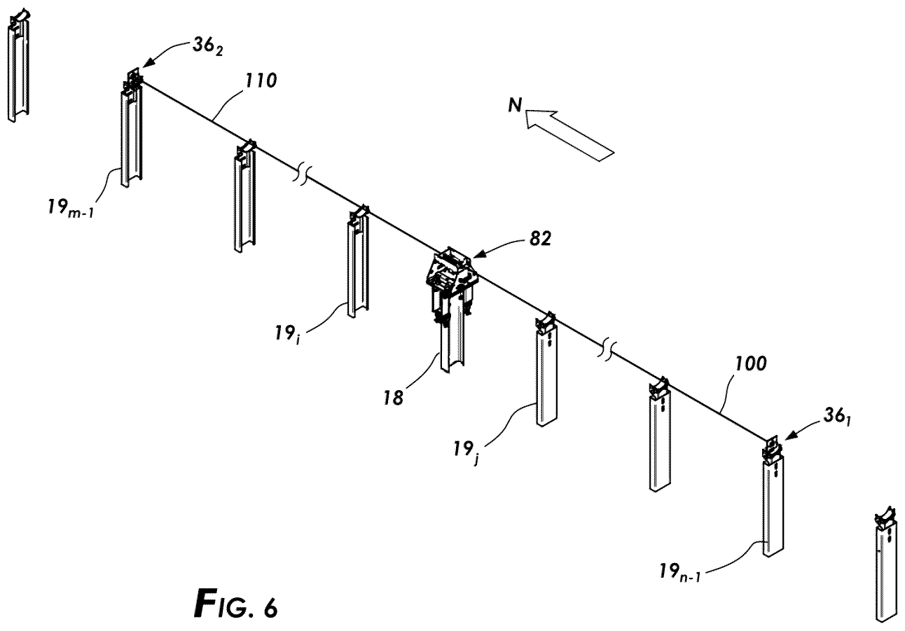

Shown in perspective view in FIG. 6 is an example of a next step in the construction of the solar power plant 10 of FIG. 1. As shown, the target assemblies 36_{1,2} are moved from posts 19_{m,n} to the posts 19_{m-1,n-1} that are next closest to the post 18 on which the drive mount 32 and alignment fixture 82 are mounted. The above described alignment process is repeated to align brackets 76 on each of the posts 19ᵢ₋ₘ, ⱼ₋ₙ in that row 12,

Shown in FIG. 7A is an example of a drive mount 32 and properly aligned as described above and mounted onto post 18. A drive gear 30 has been mounted onto the upper bracket 38, by inserting threaded bolts through the bores 39 in the upper bracket 38. Drive gear 30 includes a circular shaped housing 120, which couples with a transversely located shaft 122. Shaft 122 rotates in response to rotation from a drive motor (not shown) directly attached to drive gear 30 or connected via a drive line (not shown). When installed, the torque tube 16 (FIG. 1) is in rotational engagement with the drive gear 30 inside housing 120. Inside the drive gear 30, the shaft 122 axis of rotation is changed from a rotation about the Z axis to an axis of rotation about the X axis and transfers rotational torque from the drive motor or drive line to the torque tube 16 for tilting the modules 14 (FIG. 1).

Shown in a perspective view in FIG. 7B is an example of a bearing assembly 126 mounted onto a bearing mount 34 after the bracket 76 is positioned on the post 19 as described above so that an axis A₁₂₆ of the bearing assembly 126 is coincident with the axis A_{C} of common rotation. As previously described, the bearing assembly 126 provides a smooth rotation of the torque tube 16 with respect to the post 19 and bearing mount 34.

In one non-limiting example of constructing a solar power plant 10 (FIG. 1), positions of a drive mount 32 (FIG. 2) and bearing mounts 34 on their respective posts 18, 19_{i-n, j-m} are adjusted and aligned so that when a torque tube 16 (FIG. 1) is installed in the row 12, the axis of the torque tube 16 is substantially straight, and the torque tube 16 has an axis of rotation that is coaxial with a common axis of rotation. In an example, the axis of the torque tube 16 is coaxial with its axis of rotation, and in alternatives, the axis of the torque tube 16 is offset from its axis of rotation. To set the positions, an alignment fixture 82 (FIG. 4) is mounted onto a drive mount 32 that is set on a post 18 in the middle of a row 12, and target assemblies 36_{1,2} are mounted onto posts 19_{m,n} on opposing ends of the row 12. The drive mount 32 is spaced upward from the post 18 by a shim 52, and supported to the post 18 by elevator assemblies 50. Using a level sensor 104 in the alignment fixture 82, inclination or tilt of an upper surface of the drive mount 32 in the East-West direction is measured, and if not level, is adjusted to 0°+/−0.5° tilt. One or more of the elevation, tilt, and lateral position of the alignment fixture 82 are selectively adjusted until reflective medium 69₁ is viewable through eyehole 107 and aperture 104 and reflective medium 69₂ is viewable through eyehole 106 and aperture 105. The elevation and tilt are adjustable by manipulating the elevator assembly 50 and the lateral position is adjustable by sliding the drive mount 32 laterally over the post 18 or by using the yaw adjustment 102. The laser 100 on the alignment fixture 82 is energized to generate laser beams 108, 110 that strike reflective mediums 69_{1,2} respectively. The elevation and/or lateral position of the alignment fixture 82 is further adjusted as needed until the lasers 108, 110 strike the reflective mediums 69_{1, 2} within zones Z_{1, 2} that circumscribe the centers of the crosshair marks 70_{1, 2}. Bolts 42 are then tightened to secure drive mount 32 in place. Positions of the brackets 76_{1, 2} are adjusted until the lasers 108, 110 are aligned with the centers of the crosshair marks 70_{1, 2}. The brackets 76_{1, 2} are then secured to the posts 19_{m, n} by tightening bolts 78_{1, 2}. Using the eyeholes 106, 107 and apertures 104, 105 for the initial or rough alignment ensures that the beams 108, 110 will land somewhere on the reflective mediums 69_{1,2}, which greatly reduces the time required for further alignment so that the beams 108, 110 are aimed at the centers of the crosshair marks 70_{1,2}. After securing the drive mount 32 and brackets 76_{1,2} in place, the reflective mediums 69_{1,2} are moved to the posts 19_{m-1, n-1} and the process is repeated until brackets on all posts 19_{1-m, 1-n} are aligned and secured. In examples, the above process is limited to a single row 12, and alternatively repeated in another row 12.

Example

In a non-limiting example of use, targets 36 are attached to bearing mounts 34 at the outermost end posts 19_{m, n} (north and south ends) of a tracker row 12. The bearing mounts 34 are moved to their vertical and horizontal adjustment range midpoints and fasteners 78, 116 are temporarily tightened. A shim spacer 52 (temporary support member) is installed under a drive mount bracket 38 to position the drive mount 32 proximate a center of a vertical adjustment range while also supporting its weight. Elevator adjustments 62 are installed onto the drive post 18 to support the weight of the drive mount 32. The alignment fixture 82 is set on the drive mount 32 and locked in place, and the temporary support 52 is removed. At this point, the drive mount 32 and alignment fixture 82 are supported by the elevator adjustments 62. Using knobs 66 on the elevator adjustments 62, the drive mount 32 and alignment fixture 82 are leveled in the direction transverse (i.e., East/West) to a direction (North/South) of the tracker row 12. The laser 100 is energized so that both lasers 108, 110 are generated, and using sight features on the alignment fixture 82, rough adjustments are performed to aim the laser 100 so that both laser beams 108, 110 intersect targets 69 on each end of the row 12. The position and orientation of the alignment fixture 82 are adjusted so that both laser beams 108, 110 are directed to a central target zone or cross hair marks 70_{1, 2} on each row end target 69_{1, 2}. Once this is achieved, no additional adjustments will be made to the position or orientation of the alignment fixture 82. At each row end target 69_{1, 2}, the bearing mount 34_{1, 2} is loosened and moved slightly to center the spot where the laser beams 108, 110 intersect the target 69_{1,2} to be on the cross hair marks target 70_{1, 2}, and fasteners 78_{1, 2}, 116_{1,2} securing the bearing mounts 34_{1,} 2 are tightened. Each laser target 69_{1, 2} is moved to the adjacent bearing mount 34_{1, 2} towards the center of the row 12. The bearing mounts 34_{1,2} are moved so the laser beams 108, 110 are centered on the cross hair marks 70_{1, 2}, and the bearing mounts 34_{1, 2} are tightened to their respective posts 19. The above steps are repeated to align and tighten each bearing mount 34 along the tracker row 12. After all the bearing mounts 34 are tightened, alignment is complete and the laser 100 is deactivated. Fasteners 41, 42, 48 securing the drive mount brackets 38, 40 are tightened, and all fasteners for the drive mount 32 and the bearing mounts 34 are torqued.

The present invention described herein, therefore, is well adapted to carry out the objectives and attain the ends and advantages mentioned, as well as others inherent therein. While one or more embodiments have been given for purposes of disclosure, numerous changes exist in the details of procedures for accomplishing the desired results. These are intended to be encompassed within the spirit of the present invention disclosed herein and the scope of the appended claims. What is claimed is.

1. A method for constructing a row of solar panels comprising:
placing a first target assembly to a first mount that is coupled with a first post set in the ground;
placing a second target assembly to a second mount that is coupled with a second post set in the ground distal from the first post;
setting an alignment fixture to a middle mount that is coupled with a middle post set in the ground between the first and second posts, the alignment fixture comprising a housing and a dual laser coupled with the housing;
energizing the laser to generate a first laser beam directed towards the first target assembly and a second laser directed towards the second target assembly, the first and second laser beams being coaxial;
adjusting placement of the housing to direct the first laser beam onto the first target assembly and to direct the second laser beam onto the second target assembly;
aligning the first laser beam with a designated portion of the first target assembly and aligning the second laser beam with a designated portion of the second target assembly by further adjusting placement of the alignment fixture; and
installing a torque tube between the first, second, and middle mounts having an axis of rotation that is coaxial with the first and second laser beams when aligned with the designated portions of the first and second target assemblies.

2. The method of claim 1, wherein the first mount is coupled to the first post by a first bracket and the second mount is coupled to the second post by a second bracket, and wherein the step of aligning comprises one or more of adjusting a position of the first bracket with respect to the first post, adjusting a position of the second bracket with respect to the second post, and adjusting a position of the first bracket with respect to the first post and adjusting a position of the second bracket with respect to the second post.

3. The method of claim 1, wherein the middle mount is coupled to the middle post by a middle bracket that is laterally and vertically adjustable with respect to the second post, and wherein the step of aligning comprises adjusting a position of the middle bracket with respect to the middle post.

4. The method of claim 3, further comprising supporting the middle mount on the middle post with an elevator assembly comprising a base that is releasably coupled with the middle post, a pedestal supporting a lower end of the middle mount, and a lifting screw threadingly engaged with the base and having an end abutting a side of the pedestal opposite the middle mount.

5. The method of claim 4, wherein the elevator assembly further comprises a quick release tab to selectively disengage the lift screw from the base.

6. The method of claim 1, wherein the designated portion of the first target assembly medium is disposed at a designated location with respect to the first mount and wherein the designated portion of the second target assembly medium is disposed at a designated location with respect to the second mount.

7. The method of claim 6, wherein the first target assembly comprises a first reflective medium, wherein the second target assembly comprises a second reflective medium, and wherein the step of alignment comprises viewing reflections of the first and second laser beams from the first and second reflective mediums.

8. The method of claim 1, wherein adjusting placement of the housing to direct the first laser beam onto the first target assembly and to direct the second laser beam onto the second target assembly comprises using sights on the housing.

9. The method of claim 8, wherein the sights comprise apertures formed through sidewalls of the housing.

10. The method of claim 2, wherein the first and second posts comprise end posts of a row of posts, the method further comprising moving the first and second target assemblies to mounts on posts closer to the alignment fixture, adjusting positions of the first and second target assemblies so that the designated portions of the first and second target assemblies are intersected by the first and second laser beams.

11. The method of claim 10, further comprising securing the middle bracket to the middle post.

12. The method of claim 11, further comprising securing mounts on the posts closer to the alignment fixture after the first and second lasers are aimed onto the designated portions of the first and second target assemblies.

13. The method of claim 1, wherein the step of alignment further comprises adjusting a tilt of the alignment fixture.

14. A system for aligning mounts on spaced apart posts in a row of solar panels, the system comprising:
a target assembly comprising a reflective medium, the target assembly strategically dimensioned, so that when the target assembly is coupled to a first one of the posts, the reflective medium is disposed in a designated orientation and at a designated location; and
an alignment fixture selectively coupled with a second one of the posts, the alignment fixture comprising,
a housing,
a laser coupled with the housing that selectively projects a laser beam towards the reflective medium, and
.

15. The system of claim 14, wherein when the target is viewable through the sighting system the reflective medium is in the path of the laser beam.

16. The system of claim 14, wherein the target assembly is coupled to the first one of the posts by a first bracket, wherein the alignment fixture is coupled to the second one of the posts by a second bracket, wherein when the reflective medium is in the path of the laser beam, positions of the first and second brackets are strategically adjustable by amounts so that the laser beam intersects a center of the reflective medium.

17. The system of claim 14, further comprising a target mount releasably coupled with a first one of the mounts and strategically dimensioned so that when coupled with the first one of the mounts the reflective medium is in the designated position and orientation.

18. The system of claim 14, further comprising an elevator assembly comprising a base that is releasably coupled with one of the posts, a pedestal supporting a lower end of a one of the mounts, and a lifting screw threadingly engaged with the base and having an end abutting a side of the pedestal opposite the one of the mounts, and a quick release tab to selectively disengage the lift screw from the base.

19. The system of claim 14, wherein the laser beam comprises a first laser beam, wherein the laser selectively generates a second laser beam that is coaxial with the first laser beam and in an opposite direction.

20. The system of claim 14, where the sighting system comprises apertures formed in sidewalls of the housing at strategic locations, so that when the target is viewable through the apertures, the reflective medium is in a path of the laser beam.
